(19) United States
(12) Patent Application Publication
(10) Pub. No.: US 2018/0221958 A1
(43) Pub. Date: Aug. 9, 2018

(54) PARTS AND METHODS FOR PRODUCING PARTS USING HYBRID ADDITIVE MANUFACTURING TECHNIQUES

(71) Applicant: GENERAL ELECTRIC COMPANY, Schenectady, NY (US)

(72) Inventors: Kerem TORUN, Istanbul (TR); Onur ONDER, Istanbul (TR); Kemal COSKUN, Istanbul (TR); Banu BERME, Istanbul (TR); Hulya ARSLAN, Istanbul (TR); Bora ISLIER, Istanbul (TR)

(21) Appl. No.: 15/426,780

(22) Filed: Feb. 7, 2017

(51) Int. Cl. B22F 7/08; B22F 3/24; B22F 3/105; B33Y 10/00; B33Y 80/00; B22F 5/00; B23K 15/00; B23K 26/342; B23K 26/00

(52) U.S. Cl. CPC B22F 7/08; B22F 3/24; B22F 3/1055; B33Y 10/00; B33Y 80/00; B23K 2201/001; B23K 15/0086; B23K 26/342; B23K 26/0093; B22F 2003/247; B22F 5/009

(57) ABSTRACT

Components and methods of producing hybrid additively manufactured components. A component produced using stock or traditionally produced materials as one section of the finished component and an additively manufactured portion as a second section of the finished component. The component and method of producing the component may be used, along with other benefits to decreased tooling/manufacturing time, decreased cost, and decreased waste of materials. Further the disclosure provides an improved method of producing structurally optimized components.

### INTRODUCTION

The disclosure relates to an improved method of producing components using a hybrid manufacturing technique. The disclosure provides an improved method of producing components for decreased tooling/manufacturing time, decreased cost, decreased waste of materials. Further, the disclosure provides an improved method of producing structurally optimized components for one more of the following characteristics: structural integrity, thermo-mechanical load carrying capability, buckling resistance, containment, and improved life of the component.

### BACKGROUND

Gas turbine engines generally include at least one compressor and at least one turbine section each having rotating blades contained within an engine housing. One of the goals in designing an engine housing is to maintain a lightweight structure while still providing enough strength to contain any rotating blade that may break (i.e. blade containment). Because any broken blades must be contained within the housing, the walls of engine housings must be manufactured to ensure broken blades do not puncture the housing.

Proposals to reduce weight, strengthen the turbine case, and/or to decrease the cost and increase efficiency of manufacturing have relied on additive manufacturing (AM) techniques. When an annular structure for use in a turbine is manufactured, AM may be utilized to form an annular and/or cylindrical component at a net shape or at a near net shape for further finishing. AM techniques are advantageous during the manufacturing process of annular components, and other components, in that AM techniques offer high geometric flexibility and when compared to subtractive manufacturing techniques or casting techniques and further may offer cost savings and flexibility in enabling changes to be made during the production process without re-tooling. However, components manufactured using AM techniques may not exhibit the desired properties of materials formed using more conventional manufacturing techniques (e.g. forging). Further, during the abovementioned example process, the additively manufactured component is generally formed on a disposable or sacrificial and/or reusable base substrate. After the component is complete, the base substrate is removed, as the sole purpose of the base substrate is to provide a base and/or support for forming the AM component.

### SUMMARY OF THE INVENTION

Through the use of additive manufacturing techniques, an engine component may be formed on a base substrate, by employing the novel process to form a component discussed below, a component can be formed that incorporates the base material as part of the finished structure, thereby removing a manufacturing step from the process. Further, by employing the disclosed techniques, any one or combination of the advantages of: a reduction in material waste, a decrease in cost, and/or a decrease in manufacturing time are realized. The disclosed component and disclosed techniques further allow for components to be manufactured that utilize a hybrid structure, allowing the optimization of the structure of each portion of the component; accordingly, a component can be formed having the qualities of various materials and production processes at the locations of the component at which specific material qualities are desired. Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a flow-chart depicting a method of forming a component in accordance with one aspect of the disclosure;

FIG. 2 is a side view and top view diagram of a conventional additive manufacturing technique used to form at least part of a component in accordance with one aspect of the disclosure;

FIG. 3 is a diagram of a conventional additive manufacturing technique used to form at least part of a component in accordance with one aspect of the disclosure;

FIG. 4 is schematic diagram showing an example of a conventional apparatus for additive manufacturing;

FIG. 5 is a top view depicting a base for forming a portion of a component in accordance with one aspect of the disclosure;

FIG. 6 is a side view depicting an additive manufacturing technique used to form at least a portion of the component on the example base of FIG. 6, in accordance with one aspect of the disclosure;

FIG. 7 is a side view depicting an additive manufacturing technique used to form at least a portion of the component on the example base of FIG. 6, in accordance with one aspect of the disclosure;

FIG. 8 is a perspective view depicting a component produced using a manufacturing technique in accordance with one aspect of the disclosure;

FIG. 9 is a perspective view depicting a component produced using a manufacturing technique in accordance with one aspect of the disclosure;

FIG. 10A is a cross-sectional view depicting a component showing a portion of the flange to be machined using a manufacturing technique in accordance with one aspect of the disclosure;

FIG. 10B is an enlarged cross-sectional view of the component in FIG. 11A, showing a portion of the flange to be machined using a manufacturing technique in accordance with one aspect of the disclosure;

FIG. 10C is an enlarged cross-sectional view of the component in FIG. 11A, showing a portion of the flange shown in FIG. 10B after machining in accordance with one aspect of the disclosure;

FIG. 11 is a perspective view of bosses formed using a manufacturing technique in accordance with one aspect of the disclosure;

FIG. 12 is a perspective view of a component having bosses formed using a manufacturing technique in accordance with one aspect of the disclosure;

### DETAILED DESCRIPTION

Typically, turbine includes a compressor portion, a combustion portion, and a turbine portion. The turbine portion may include a gas generator turbine (GT) and a power turbine (PT). The majority of the description below describes an annular portion of an engine. Accordingly, the present invention may be applicable to any one of the turbine portions, the compressor portion or any other annular component of the turbine. The following detailed description sets a method of manufacturing an annular casing, and a produced annular engine casing as an example. The disclosed aspects may be implemented in the production of a high pressure turbine (HPT) or low pressure turbine (LPT), the high pressure compressor (HPC) or low pressure compressor (LPC), turbine center frame (TCF), and combustor, for example. The description should clearly enable one of ordinary skill in the art to make and use the manufacturing method and component, and the description sets forth several aspects, adaptations, variations, alternatives, and uses of the annular component, by way of example. The method of manufacturing the annular component described herein is referred to as being applied to a few aspects, namely to the construction of and resulting annular engine case. However, it is contemplated that the method of fabricating the annular structure may have general application in a broad range of systems and/or a variety of commercial, industrial, and/or consumer applications other than the manufacturing of an annular component of a turbine engine.

The abovementioned annular component may be manufactured using an additive manufacturing (AM) technique, which may include electron beam freeform fabrication, laser metal deposition (LMD), laser wire metal deposition (LMD-w), gas metal arc-welding, laser engineered net shaping (LENS), laser sintering (SLS), direct metal laser sintering (DMLS), electron beam melting (EBM), powder-fed directed-energy deposition (DED), and three dimensional printing (3DP), as examples. Any of the above additive manufacturing techniques may be used to form an engine casing or annular component from stainless steel, aluminum, titanium, Inconel 625, Inconel 718, Inconel 188, cobalt chrome, among other metal materials or any alloy. For example, the above alloys may include materials with trade names, Haynes 188®, Haynes 625 Super Alloy Inconel 625™, Chronin® 625, Altemp® 625, Nickelvac® 625, Nicrofer® 6020, Inconel 188, and any other material having material properties attractive for the formation of annular components using the abovementioned techniques. AM processes generally involve the buildup of one or more materials to make a net or near net shape (NNS) object in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. As an example, a particular type of AM process uses an energy beam, for example, an electron beam or electromagnetic radiation such as a laser beam, to sinter or melt a powder material and/or wire-stock, creating a solid three-dimensional object in which a material is bonded together.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. In general, the abovementioned processes are performed on build platform, which may be a reusable or sacrificial substrate. In the above-mentioned processes, conventionally, the build platform is removed from the component formed after a component build is complete.

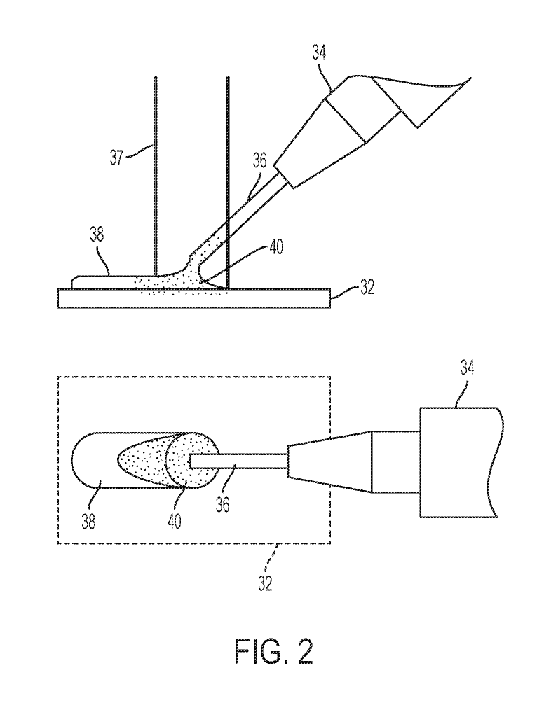

FIG. 2 is a schematic diagram showing an exemplary conventional wire fed AM apparatus and method. The apparatus may be configured to build objects, for example, a part 38, in a layer-by-layer manner by feeding wire-stock 36, fed by a wire feed apparatus 34, and sintering and/or melting the wire using an energy source 37, which may be, for example, an electron beam or electromagnetic radiation such as a laser beam. The building of the part 38, may be on a substrate 32. The energy source 37 may form a melt pool 40, which solidifies to form at least a portion of the part 38. Either the wire fed AM apparatus, the substrate, or both may be lowered and/or moved, while melting the wire-stock on any portion of the substrate 38 and/or on the previously solidified part 38 until the part is completely built up from a plurality of beads formed from the melted wire-stock. The energy source 37, may be controlled by a computer system including a processor and a memory. The computer system may determine a predetermined path for each melt pool and subsequently solidified bead to be formed, and energy source 37 to irradiate the wire material according to a pre-programmed path. After fabrication of the part 38 is complete, various post-processing procedures may be applied to the part 38. Post processing procedures include removal of excess melted wire-stock material, for example, by machining, sanding or media blasting. In the past, conventional post processing also involved removal of the part 38 from the build platform/substrate 32 through machining, for example. Other post processing procedures may include a stress release process, thermal and/or chemical post processing procedures to finish the part 38. As further examples, U.S. Pat. No. 6,143,378 and U.S. Pat. No. 8,546,717 describe conventional wire fed AM processes and are hereby incorporated by reference.

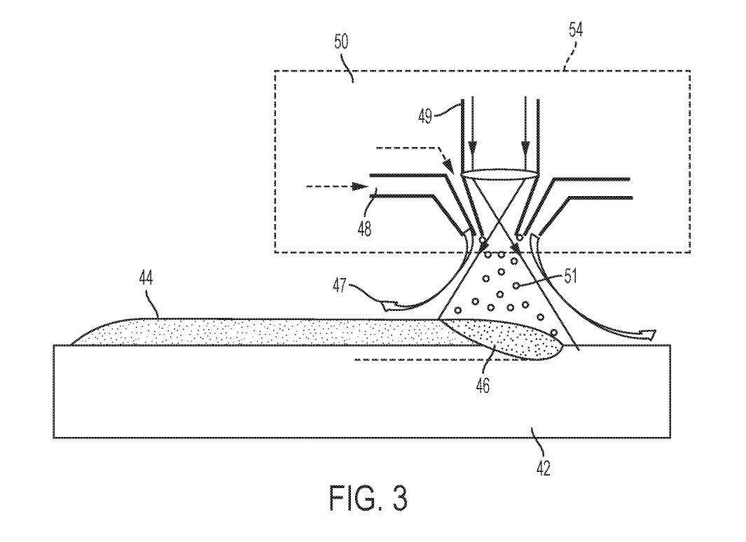

FIG. 3 is a schematic diagram showing another exemplary conventional powder based system for building an AM component. The apparatus 55, is used to build components, for example, a part formed using stacked layers 44, by sintering or melting a powder material 52 fed though a nozzle by a powder feed source 50. The powder 52 is fed along with shield gas 47 though a shield gas source 48. As the powder is fed, the powder is melted into a melt pool 46 and/or sintered by an energy source 49. The energy source 49, may be provided, for example, as an electron beam or as electromagnetic radiation such as a laser beam. The building of the part 44, may be on a substrate 42. The melt pool 46, formed when the energy source melts and/or sinters the powder 51, solidifies to form at least a portion of the part 44. Either the powder fed AM apparatus, the substrate, or both may be lowered and/or moved, to melt the wire on any portion of the substrate 42 and/or on the previously solidified part 44 until the part is completely built up from a plurality deposited layers 44 built from melted powder 51. The energy source 49, may be controlled by a computer system including a processor and a memory. The computer system may determine a predetermined path for each melt pool and subsequently solidified bead to be formed, and energy source 49 to irradiate the powder material according to a pre-programmed path. After fabrication of the part 44 is complete, various post-processing procedures may be applied to the part 44. Post processing procedures include removal of excess powder, for example, by blowing or vacuuming, machining, sanding or media blasting. Further, conventional post processing may involve removal of the part 44 from the build platform/substrate 42 through machining, for example. The part may further be subject to a stress release process. Additionally, thermal and chemical post processing procedures can be used to finish the part 42.

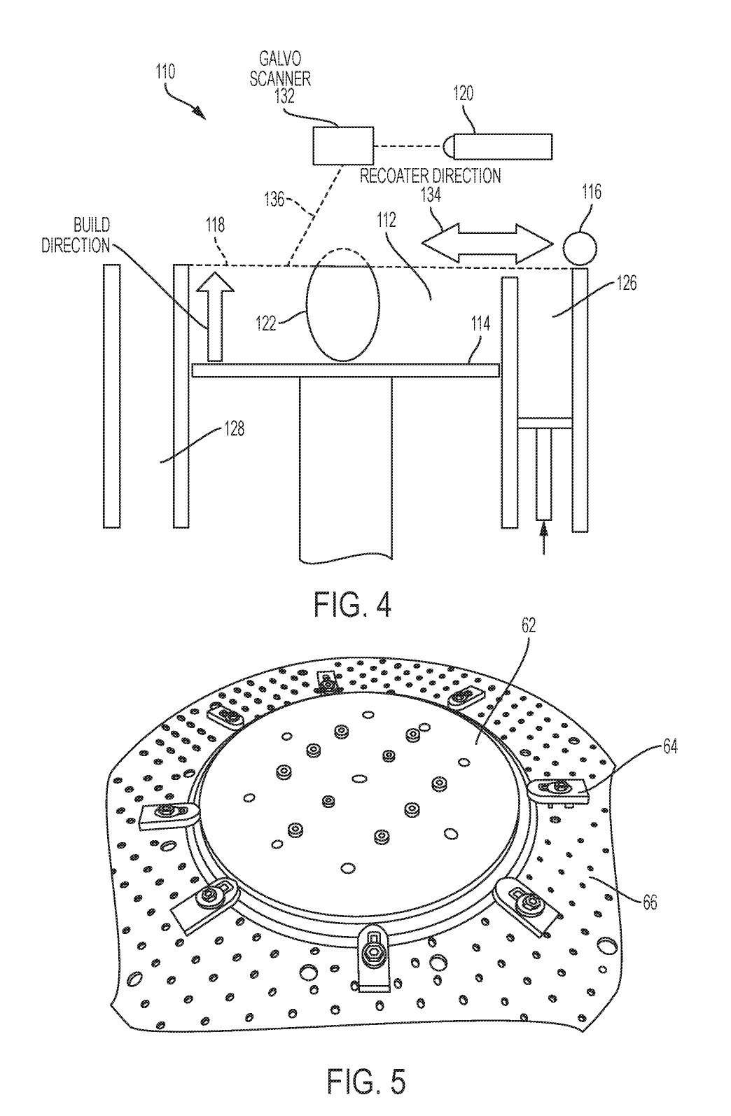

FIG. 4 is schematic diagram showing a cross-sectional view of an exemplary conventional system 110 for direct metal laser sintering (DMLS) or direct metal laser melting (DMLM). The apparatus 110 builds objects, for example, the part 122, in a layer-by-layer manner by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The build plate 114 is lowered and another layer of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of excess powder, for example, by blowing or vacuuming, machining, sanding or media blasting. Further, conventional post processing may involve removal of the part 122 from the build platform/substrate through machining, for example. Other post processing procedures include a stress release process. Additionally, thermal and chemical post processing procedures can be used to finish the part 122.

Any of the abovementioned AM processes may be controlled by a computer executing a control program. For example, the apparatus 110 includes a processor (e.g., a microprocessor) executing firmware, an operating system, or other software that provides an interface between the apparatus 110 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly. One having ordinary skill in the art would fully appreciate the abovementioned control program may be applicable to any of the abovementioned AM processes. Further, the abovementioned computer control may be applicable to any subtractive manufacturing or any pre or post processing techniques employed in any post processing or hybrid process.

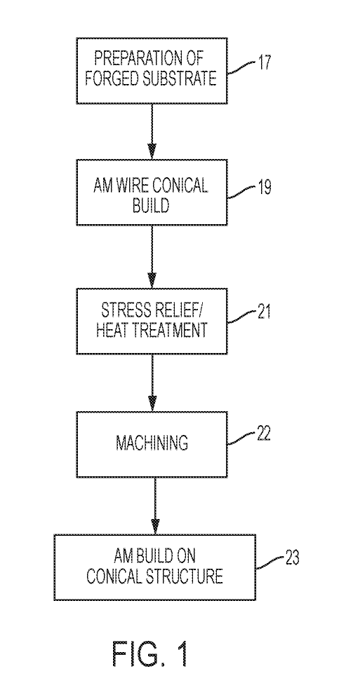

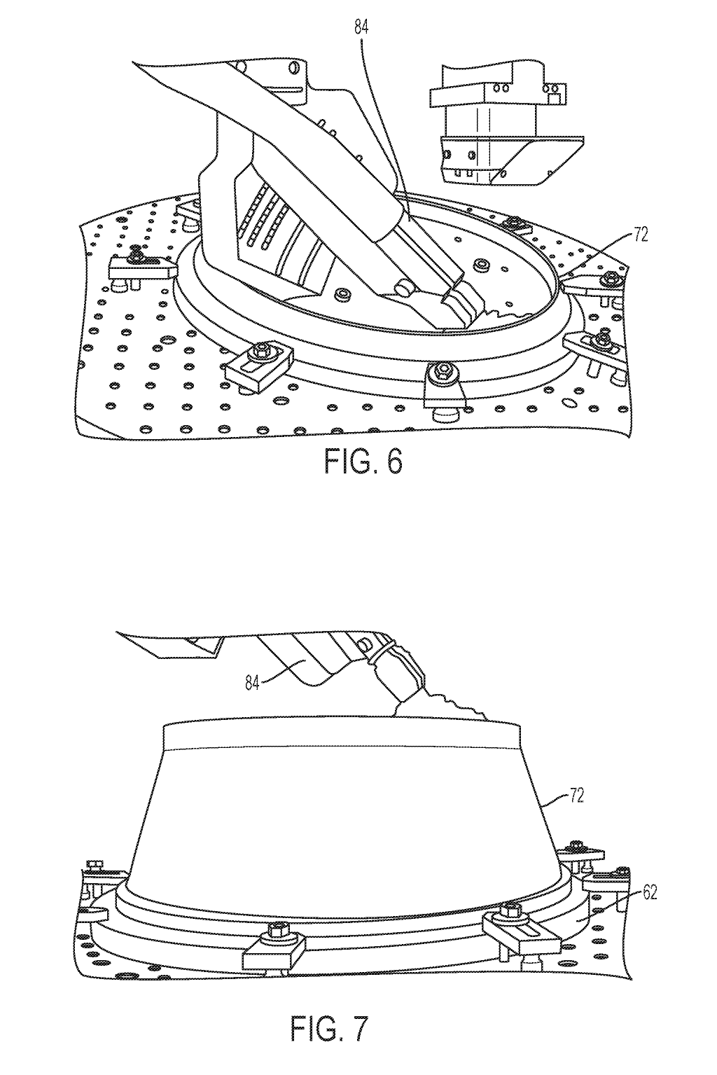

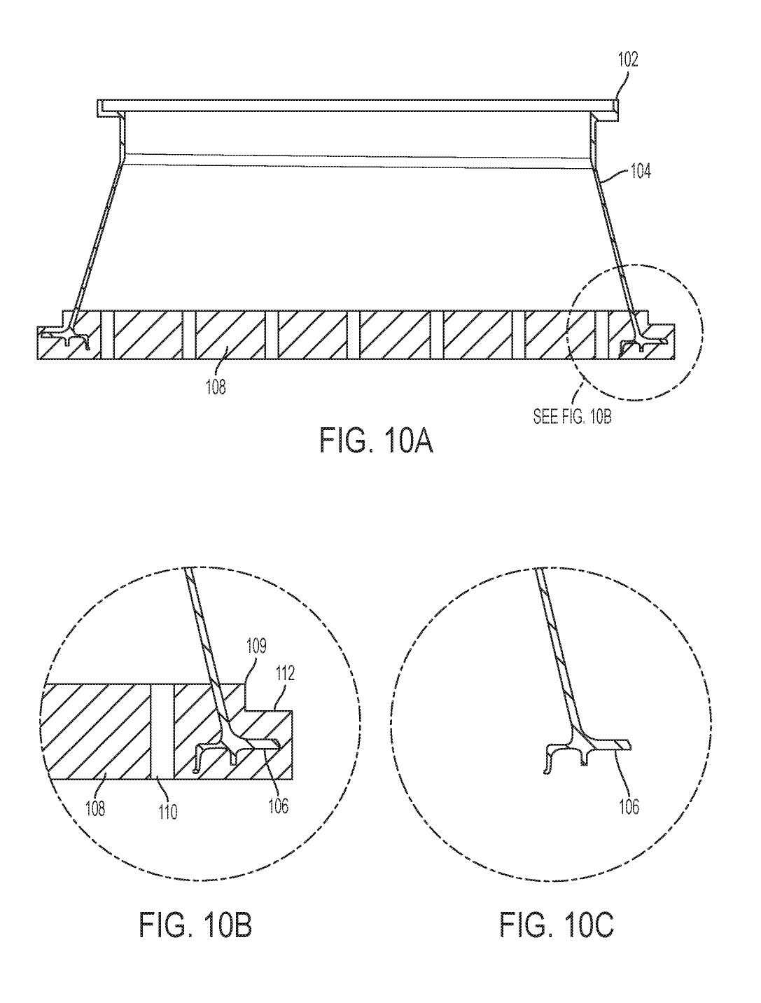

The flowchart in FIG. 1 depicts one aspect of the disclosure. Reference 17 involves the selection or forming of a base substrate (an example of which is shown in FIG. 6). The base substrate may be formed of any suitable material. The base substrate 62, may be supplied as a raw material or may have any preparatory process applied. For example, the material may be sanded, media blasted, and/or may be prepared by machining, forging, and/or annealing. Further the base substrate may be chemically treated. The base substrate may further be provided as a supplied forged substrate, and may be machined either before and/or after the below mentioned AM process is applied. For example, as shown in FIG. 6, the base substrate may be machined into a round base and may have at least a single machined step portion 64 for either clamping to a work-surface 66 or for forming a section of the desired geometry of the finished product. Further, the base substrate may be provided with an annular raised portion and/or a channel (not shown) which may correspond with the portion of the substrate at which an AM build is to be applied. The base portion 62 may further be drilled either to assist in mounting the substrate 62 to the base 66 and/or may be drilled for holes required on the finished part. The substrate 62 may further be machined or provided as a ring having a center opening (as shown in FIG. 10).

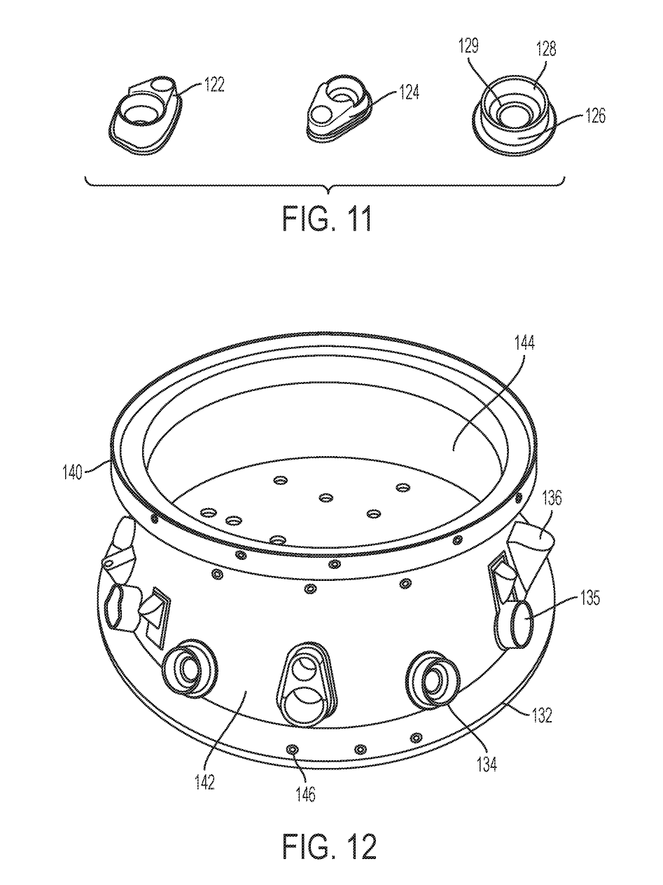

The base portion 66 may be pre-formed as a flange having any desired mounting holes, provisions, or portions to allow for sealing or mating of the flange with desired mating surfaces when completed component is assembled. The flange and/or base substrate 62 may be a material having optimal characteristics for the finished geometry associated with the base portion. For example, a flange portion may require the mechanical and material characteristics of a forged material (e.g. improved elongation, yield strength, ultimate tensile strength). Further the flange may subject to any processing to optimize the mechanical characteristics for use (e.g. hot working, cold working, annealing, and/or hardening). The alloy or material used for as the base substrate may be varied or different than the material used for the below mentioned AM process. As shown in FIGS. 11A and 11B, the base 108 substrate may be sourced or machined prior to an AM build to have at least one hole 110, and may be machined or forged to have a step portion 112. The base 108, may be selected and prepared in anticipation of a final machining of a flange portion 106.

As shown in reference 13 of FIG. 1, an AM technique may be applied to the substrate. As an example, any one of the above mentioned laser wire AM process may be applied to the base substrate to build the annular portion of the component. As shown in the example component depicted in FIGS. 6-8, the abovementioned AM process may be used to form an annular portion of the component 72 on the base substrate 62. The annular portion of the component may be formed layer by layer, either by rotation of the AM apparatus 84 and/or a rotation of the base portion 66. Further the base portion 66 and/or the AM apparatus 84 may be angled during the build process to form a second flange 140, an example of the second flange is shown in FIGS. 10 and 13. The annular portion, is not limited to, and may be formed of any of the abovementioned materials and formed using any one of or combination of the above mentioned AM processes. An AM process may be selected based on the desired cost, accuracy, repeatability, resolution, stability and/or mechanical properties of the build, and/or a desired build rate. For example, when forming a large component having an annular structure, one of the above mentioned laser wire AM processes may provide the benefit of a faster and more efficient build at the expense of resolution and accuracy. Further, the annular portion 72 may be formed to have different material properties from the base portion 62. For example, the annular portion of the component formed using an AM process may exhibit material properties (e.g. yield strength, ultimate tensile strength, elongation) between a cast and a forged material, which may be desirable in terms of stresses the annular component is subjected to and/or the cost effectiveness of the completed component. The forged base portion 62, may be preferable as a flange, as a forged material may exhibit higher yield strength, higher ultimate tensile strength, elongation, and reduced porosity and/or cavities and voids throughout the material than the annular portion 72 formed using an AM process. Accordingly, by providing the base portion 62 as a portion of the finished component the advantages of both a forged material for the flange and an annular structure formed using an AM process may be realized, as one example.

Based on the above mentioned example, the yield strength at 600° C. of the annular portion 72, represented by variable C, formed of the same material as the forged base material represented by variable X may satisfy the following equation:

C≤0.87X Equation 1

Further, as an example, the ultimate tensile strength at 600° C. of the annular portion 72, represented by variable Y, formed of the same material as the forged base material represented by variable G may satisfy the following equation:

Y≤0.85G Equation 2

Elongation at 600° C. of the annular portion 72, represented by variable T, formed of the same material as the forged base material represented by variable F may satisfy the following equation:

T≤0.82F. Equation 3

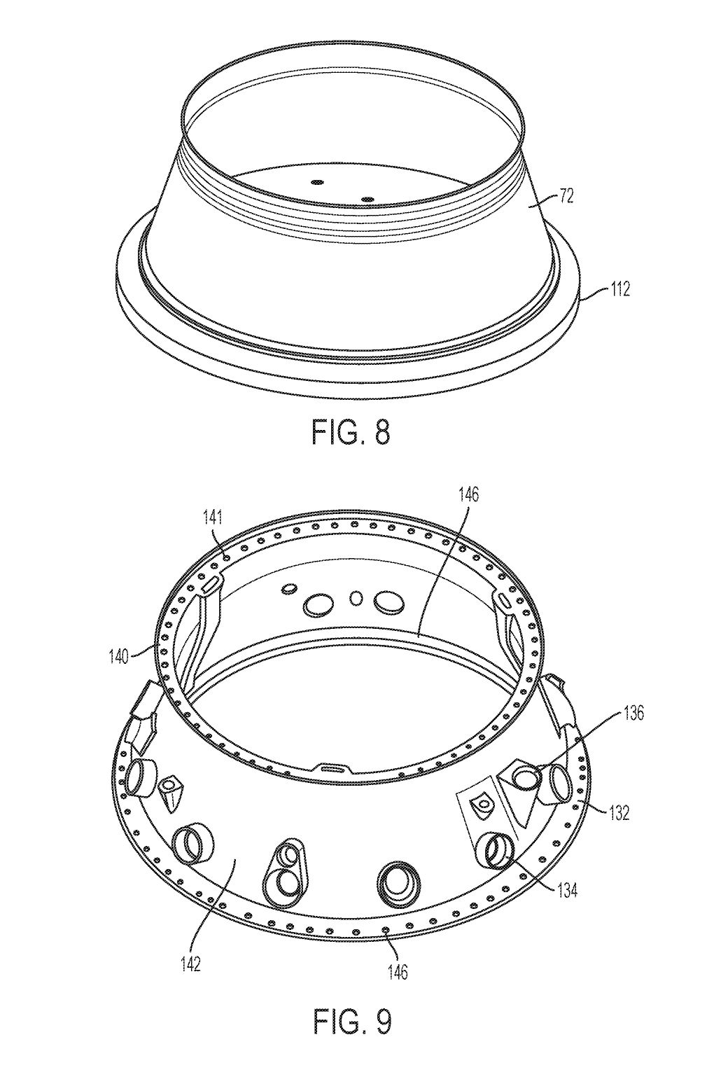

As shown in FIGS. 8, 9, 10, and 12, once a net shape AM process is performed on the base 62, 112, 108, the surface of the built AM portion of the component and/or the base may be subject to a stress relief and/or heat treatment process (FIG. 2, reference 21). Step 21 may include, annealing, stress relief annealing, thermal treatment, shot peening, vibratory stress relief, tempering, quenching, and/or any chemical process may be applied to the build. As shown in FIG. 2, step 22, the outer and/or inner annular structure may further be machined to remove any excess material imparted during the AM build process. The flange or base portion 62, 112, 108 may further be machined either before and/or after or during the machining of the annular AM portion 72 of the component.

As shown in reference 23 of FIG. 1, the annular surface 72 (FIG. 13, reference 142), may further be subject to an additional AM process. The additional AM process may be employed to form a portion of the component including at least a single or a plurality of bosses 134 or provisions 136. The bosses and/or provisions may be formed using any one of the abovementioned AM processes and may be formed using a different AM process than the process used to form the annular portion 72, 142 of the component. The AM process in step 23 may be selected based on the desired cost, accuracy, repeatability, resolution, stability and/or mechanical properties of the build, and/or a desired build rate of the portion of the component to be formed on the annular surface 72. For example, as shown in FIGS. 10, 12, and 13, a powder based AM process as described above and shown in FIG. 4 may be employed to form bosses 122, 124, 135, 136, and provision 136. By employing the above mentioned powder based AM process, each boss may be formed with higher resolution and with greater accuracy than a wire based AM process, for example. Each boss may include a desired profile, which may include specific geometries such as an outer flange 126, an inner flange 129 and a step portion 129. The bosses and/or provisions may further be subject to post processing after the AM process is complete. For instance, each of the bosses may include removal of excess powder, for example, by blowing or vacuuming, machining, sanding or media blasting. Other post processing procedures may include a stress release process. Additionally, thermal and chemical post processing procedures can be used to finish any one of the above mentioned bosses and/or provisions.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

What is claimed is:

1. An annular turbine engine component comprising:
a forged base formed of a forged material having a yield strength X
a metallic conical portion joined with the forged base, the metallic conical portion formed of a material having a yield strength Y and satisfying the equation Y≤0.87X.

2. The annular turbine engine component of claim 1, wherein the metallic conical portion has at least one boss formed on the surface.

3. The annular turbine engine component of claim 1, wherein the forged base is an annular ring.

4. The annular turbine engine component of claim 3, wherein the forged annular ring comprises a first flange portion.

5. The annular turbine engine component of claim 4, wherein the metallic conical portion comprises a second flange portion.

6. The annular turbine engine component of claim 1, wherein the forged annular base has an ultimate tensile strength at 600° C. represented by X, and the metallic conical portion has an ultimate tensile strength at 600° C. represented by C, wherein the equation C≤0.85X is satisfied.

7. The annular turbine engine component of claim 1, wherein the forged annular base has an elongation at 600° C. represented by F, and the metallic conical portion has an elongation at 600° C. represented by T, wherein the equation T≤0.82F is satisfied.

8. A method of making an annular turbine engine component comprising:
depositing, using a wire fed additive manufacturing process, a conical component on a forged base, wherein the forged base is formed into a circular flange.

9. The method of producing the part of claim 8 further comprising:
machining the forged base to form an annular flange, wherein the forged base is machined after the annular structure is formed on the forged base.

10. The method of producing the part of claim 8 further comprising:
machining the forged base to form an annular flange, wherein the forged base is machined before the annular structure is formed on the forged base.

11. The method of producing the part of claim 8, wherein after the conical component is deposited, the conical component is machined.

12. The method of producing the part of claim 11, wherein a powder fed additive manufacturing process is used to form at least one of a boss and a provision on the conical component.

13. A method of producing a part comprising:
using a first additive manufacturing process to form an annular structure on a forged base plate, the first additive manufacturing process comprising:
feeding a source wire and irradiating the source wire with an energy source to form a melt pool on a first surface of a forged base plate;
moving at least one of the source wire and energy source, and the forged base substrate while irradiating the source wire with an energy beam to form a first growth surface on the first surface;
(a) moving at least one of the source wire and energy source; and the forged base substrate while irradiating the source wire to form a melt pool on a previously solidified growth surface;
(b) repeating step (a) until an additively manufactured annular structure is formed on the forged base plate, wherein both the forged base substrate and additively manufactured annular structure become at least a portion of the finished part.

14. The method of producing a part of claim 13 further comprising:
subjecting at least one surface of the annular structure to a second additive manufacturing process, the second process comprising steps of:
(a) irradiating a layer of powder with an energy beam in a series of scan lines to form a fused region;
(b) providing a subsequent layer of powder; and
(c) repeating steps (a) and (b) until a third portion is formed on the at least one surface of the annular structure.

15. The method of producing the part of claim 13 further comprising:
machining the forged base substrate to form an annular flange, wherein the forged base plate is machined after the annular structure is formed on the forged base plate.

16. The method of producing the part of claim 13 further comprising:
machining the forged base plate to form an annular flange, wherein the forged base plate is machined before the annular structure is formed on the base substrate.

17. The method of producing the part of claim 13, wherein the annular structure has a central axis and has at least one inner surface and an outer surface, wherein the inner surface is closer to the central axis than the outer surface; the method further comprising steps of:
machining the outer surface and the forged base plate so that a first annular outer surface is formed, wherein the first annular outer surface is formed as an uninterrupted annular surface extending from the additively manufactured annular structure through at least a first portion of the forged base substrate.

18. The method of producing a part of claim 17, wherein a second portion of the forged base substrate is machined to form an annular flange, wherein the annular flange extends further than the first annular outer surface in an outward radial direction with respect to the central axis.

19. The method of producing the part of claim 14, wherein the second additive manufacturing process is used to form at least one mounting boss on at least on surface of the annular structure.
